(19) United States
(12) Patent Application Publication
(10) Pub. No.: US 2006/0269283 A1
(43) Pub. Date: Nov. 30, 2006

(54) Optical transceiver with function for monitoring operating and ambient conditions

(76) Inventor: Hirotake Iwadate, Yokohama-shi (JP)

Correspondence Address: SMITH, GAMBRELL & RUSSELL, 1850 M STREET, N.W., SUITE 800, WASHINGTON, DC, 20036, US

(21) Appl. No.: 11/433,833

(22) Filed: May 15, 2006

(30) Foreign Application Priority Data
May 16, 2005 (JP) P. 2005-142926

(51) Int. Cl. H04B 10/08

(52) U.S. Cl. 398/22; 398/138

(57) ABSTRACT

The present invention is to provide an optical transceiver with a function to investigate a cause of a trouble in facilitated. The transceiver of the invention includes various monitoring unit that monitors parameters of operating and ambient conditions, a first memory that stores at least one of the maximum and the minimum of each monitored parameter, and a comparator unit that compares the monitored parameter with at least one of the maximum and minimum value stored in the first memory and rewrites the first memory. This comparator unit rewrites the first memory when the monitored parameter is greater than the maximum value in the memory or the monitored parameter is smaller than the minimum value in the memory.

### BACKGROUND OF THE INVENTION

1. Field of the Invention

The present invention relates to an optical transceiver with functions of the optical transmission and the optical reception.

2. Related Art

An optical transceiver causes a breakdown or extremely shortens its life when it is used in conditions out of the guaranteed range, for example, a power supply out of the guaranteed voltage or a temperature out of the operable range. The United States patent application published as US 2002/0149821A has disclosed an optical transceiver with a monitoring function to investigate the trouble or the extraordinary operating condition promptly. In the optical transceiver disclosed therein sets an error flag in a memory when a monitored parameter is out of a threshold range.

However, in the case that only the error flag is set in the memory, it left unclear how apart the monitored value from the threshold. Accordingly, even if the monitored value exceeds the threshold, the cause of the trouble may be not investigated. Practically, when the threshold is set within the absolute maximum rating, only the error flag does not contribute the analysis of the cause. Therefore, the present invention is to provide an optical transceiver with a function to investigate the cause of the trouble in facilitated.

### SUMMARY OF THE INVENTION

A feature of an optical transceiver according to the present invention is to comprise a monitoring unit, a first memory, and a comparator unit. The monitoring unit monitors a parameter corresponding to an operating or ambient condition of the optical transceiver, such as inner temperature of the transceiver, power supply voltage supplied thereto, bias current for the laser diode installed therein, and optical input and output levels. The first memory stores at least one of maximum and minimum values for each parameter monitored by the monitoring unit. The comparator unit compares the monitored parameter with at least one of the minimum and maximum values corresponding to the monitored parameter and stored in the first memory. Moreover, the comparator unit rewrites the maximum or minimum values in the first memory when the monitored parameter is over the maximum value or the monitored parameter is below the minimum value. Thus, the transceiver holds the maximum and minimum value of the parameter corresponding to the operation and ambience of the transceiver, is may be facilitated to investigate a cause of a trouble appeared therein.

The transceiver according to the invention may provide a second memory that stores a threshold and an error flag. The comparator unit may set the error flag in the second memory when it compares the monitored parameter with the threshold and the monitored parameter is out of the threshold. The comparator unit may rewrite the maximum or minimum value in the first memory when the monitored parameter is over the maximum value and, at the same time, is out of the threshold, or when the monitored parameter is below the minimum value and, at the same time, is out of the threshold. Moreover, the optical transceiver may further provide an interface connected to the first and second memories, and a host system that installs the optical transceiver. The host system may access the first and second memories from the outside of the transceiver through the interface to read the maximum or minimum values from the first memory, to read the error flag from the second memory, and to write the threshold in the second memory. Thus, the host system may directly investigate the cause of the trouble occurred in the transceiver from the outside thereof.

The optical transceiver may further provide a timer to count an operating time of the transceiver and to store an accumulated time. The comparator unit may store the accumulated time in connection with the rewriting of the maximum or minimum value in the first memory. This may further facilitate the investigation of the cause of the trouble occurred in the transceiver.

### BRIEF DESCRIPTION OF DRAWINGS

FIG. 1 is a block diagram schematically showing an embodiment of an optical transceiver according to the present invention; and

FIG. 2 is a block diagram of a monitoring unit included in the optical transceiver shown in FIG. 1.

### DESCRIPTION OF PREFERRED EMBODIMENTS

Next, preferred embodiments of the present invention will be described as referring to accompanying drawings. In the specification and the drawings, the same symbols or numerals will refer to the same elements without overlapping explanations.

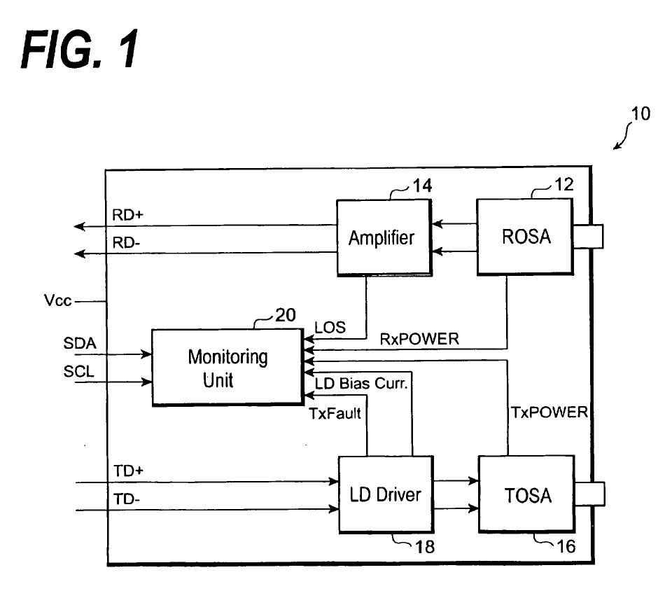

FIG. 1 is a schematic block diagram of an optical transceiver according to an embodiment of the present invention. The optical transceiver 10, which has a function of the optical transmitter and the optical receiver, comprises a receiving optical sub-assembly (hereinafter denoted as ROSA) 12, an amplifier 14, a transmitting optical sub-assembly (hereinafter denoted as TOSA) 16, a laser driver 18, and a monitoring unit 20.

The ROSA 12 is configured to receive an optical input to the optical transceiver 10, and to generate an electrical output corresponding to the optical input. The ROSA 12 includes a photodiode (hereinafter denoted as PD) to receive the optical input and to convert it into the electrical output. The amplifier 14 amplifies this electrical output from the PD and outputs a differential signals, RD+ and RD−, whose phases are opposite to each other. The amplifier 14 further provides a function to output a signal named as the LOS (Loss of Signal) when the optical input to the transceiver 10 becomes less than a minimum detectable level.

The TOSA 16, receiving a driving signal from the laser driver 18, generates an optical output corresponding to the driving signal. The laser driver 18, receiving an electrical signal from the outside of the optical transceiver 10, generates the driving signal. The TOSA 16 includes a laser diode (hereinafter denoted as LD), and the laser driver 18 drives this LD by supplying a bias current to the LD. Moreover, the laser driver 18, receiving the differential signals, TD+ and TD−, supplies a modulation current corresponding to these differential signals, TD+ and TD−. Accordingly, the LD outputs light corresponding to the differential signals, TD+ and TD−. The TOSA 16 further includes a PD for monitoring an optical output from the LD within the TOSA 16. The laser driver has a function to generate a monitoring signal TxFault that reflects a trouble occurred to the LD.

The optical transceiver 10 further provides a function to watch parameters regarding to an operation of the transceiver 10 and to an ambient conditions. These parameters are, for example, a level of the power supply Vcc supplied to the transceiver 10, a temperature of the transceiver 10, an optical input level to the ROSA 12, the bias current of the LD in the TOSA 16, and an optical output level of the TOSA 16. The monitoring function may be realized in the monitoring unit 20.

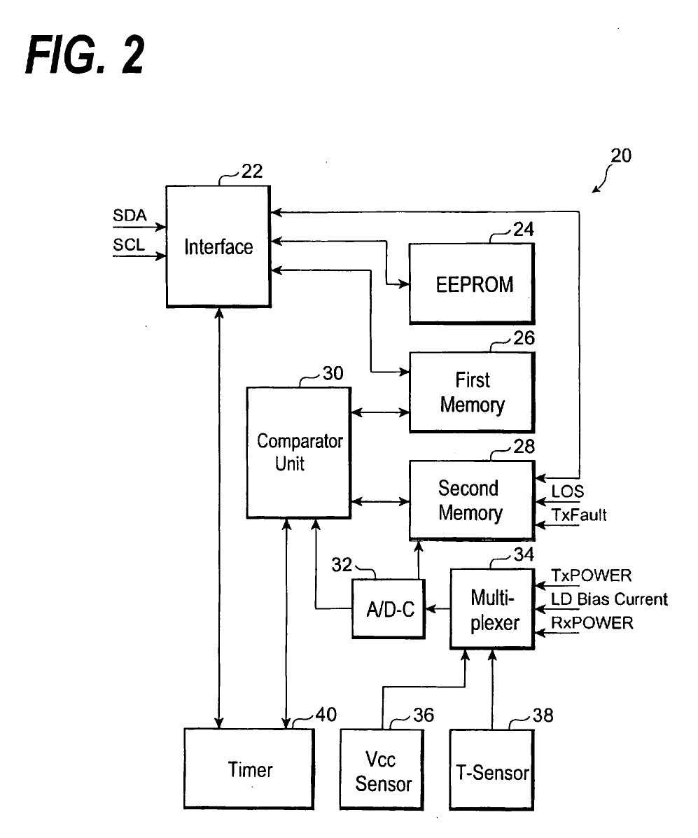

FIG. 2 is a block diagram of the monitoring unit 20. The monitoring unit 20 includes the interface 22 with a paired wire interface that handles a serial digital signal SDA and a serial clock signal SCL. The transceiver 10 communicates with the outside thereof through this interface 22, for example, the transceiver 10 receives a command from the host system, and transmits data to the host system. This interface 22 is connected to an EEPROM (Electrically Erasable Programmable Read Only Memory) 24, a first memory 26, and a second memory 28. The EEPROM 24 is a nonvolatile memory that stores the general information, initial conditions, and an identification of the transceiver 10. The first memory 26 is nonvolatile and rewritable memory that stores maximum and minimum values for monitoring parameters. This first memory 26 allocates memory spaces for respective monitoring parameters, and the maximum and minimum values for each monitoring parameter are stored in respective memory spaces independently. The second memory 28 is a rewritable memory that stores error flags set when an anomaly in the operation and in the operating conditions of the transceiver 10 are detected. The second memory 28 also stores other error flags set responding to a signal, TxFault, for detecting a fault of the TOSA and to another signal, LOS, for detecting a loss of optical input signal.

Comparator unit 30 may rewrite data in the first and second memories, 26 and 28, or may read data from the first and second memories, 26 and 28. The comparator unit 30, connected to an output of the analog-to-digital converter (hereinafter denoted as A/D-C) 32. The input of the A/D-C 32 is connected to the multiplexer, MUX, 34 for selecting the input to the A/D-C 32. The MUX 34 receives a plural analog signals that reflects various monitoring parameters, for example, the magnitude of the power supply voltage Vcc that is monitored by the Vcc sensor 36 and a temperature of the transceiver 10 monitored by the T-sensor 38. The Vcc sensor 36 monitors the magnitude of the power supply voltage and sends an analog signal indicating this magnitude Vcc. The temperature sensor 38 monitors the inner temperature of the transceiver 10 and sends an analog signal that indicates the inner temperature to the multiplexer 34. Moreover, the multiplexer 34 receives an optical input level, RxPower, measured by the ROSA 12, an optical output level, TxPower, monitored by the PD within the TOSA 16, and an analog signal indicating the bias current output from the laser driver 18. The multiplexer 34 selects one of these analog signals referred above and sends the selected signal to the A/D-C 32. The A/D-C 32 is configured to convert this analog signal into a corresponding digital form and to send the digital signal thus converted to the comparator unit 30.

The monitoring unit 20 may further include a time 40 for storing accumulative time of the operation of the transceiver 10. The timer 40 provides a RAM (Random Access Memory) and a ROM (Read Only Memory) to hold the accumulative time while the transceiver 10 is powered off. The timer 40, synchronized with the power-up of the transceiver 10, is configured to read the accumulative time from the ROM into the RAM, to start the count of the time, and to increment the accumulative time with a constant period. Powering off the transceiver 10, the timer 40 stops its count and writes the current accumulative time in the ROM. The comparator unit 30 may receive the count, namely, the accumulative time from the timer 40. The host system outside of the transceiver 10 may also access the timer via the interface 22 to get the accumulative time.

Next, the monitoring function of the transceiver 10 will be described.

The monitoring unit 20, by receiving one of the monitoring parameters from the A/D-C 32, compares this monitoring parameter with upper and lower thresholds for this parameter. The upper and lower thresholds are independently set for respective parameters. One example is; both upper and lower thresholds are set for the power supply voltage Vcc and the inner temperature, while only the upper threshold is set for the optical input level, RxPower, the optical output level, TxPower, and the bias current. These thresholds are stored in the second memory 28.

The comparator unit 30 reads the threshold corresponding to the monitored parameter received from the A/D-C 32 from the second memory 28, and compares the monitored parameter with the threshold. The parameters with both upper and lower thresholds are compared with those upper and lower thresholds. When the monitored parameter is over the upper threshold or below the lower threshold, the comparator unit 30 sets the error flag in an address allocated to the monitored parameter in the second memory 28. Independent addresses are allocated for cases when the monitored parameter is over the upper threshold and when the parameter is below the lower threshold. The error flags indicate anomalies in the operation or in the conditions of the transceiver 10. For example, when the monitored parameter is the optical output level, TxPower, or the bias current of the LD, the error flags corresponding to these parameters indicate the anomaly in the operation of the transceiver 10. On the other hand, the error flags indicate the anomaly in the operating conditions when the parameter is the magnitude of the power supply, Vcc, the temperature, or the optical input level, RxPower.

When the monitored parameter exceeds the upper threshold, the comparator unit 30 reads the maximum value of this parameter from the first memory 26. In the case the maximum value is not set in the first memory yet, the comparator unit 30 writes the present monitored value in the first memory 26 as the maximum value. On the other hand, when the maximum value is already set in the first memory, the comparator unit 30 compares the present monitored value with the maximum value in the first memory 26, and rewrites the maximum value in the first memory 26 with the present monitored value when the present monitored value exceeds the maximum value. When the present monitored value is below the maximum value, the maximum value in the first memory 26 is not rewritten.

Similarly, when the present monitored parameter is below the lower threshold, the comparator unit 30 reads the minimum value from the first memory 26. When the minimum value is not set yet, the comparator unit 30 sets the present monitored value in the first memory 26 as the minimum value. On the other hand, the minimum value is already set, the comparator unit 30 compares the present monitored parameter with the minimum value and rewrites the minimum value with the present monitored value when the present value is below the minimum value, while the minimum value in the first memory 26 is not revised when the present monitored value is not below the minimum value.

Moreover, the comparator unit 30 reads the accumulative time from the timer 40 when the minimum or maximum value is revised and writes this accumulative time in the first memory 26 relating to the minimum or maximum values.

Thus, at least one of the maximum or minimum values for respective parameters is held in the first memory 26. When the transceiver 10 is in the trouble, it may be facilitated to investigate the cause of the trouble by comparing the maximum or minimum values held in the first memory with allowable maximum or minimum values. In particular, when the upper and lower thresholds to set the error flag are within the rated range, it is hard to find the cause of the trouble only by monitoring the error flag. Detecting the maximum or minimum values of the monitored parameters, it may be facilitated to investigate the cause of the trouble.

Moreover, the present embodiment also stores the accumulative time in the first memory 26 when the maximum or minimum values are revised. Taking the accumulative time in addition to the maximum and minimum values, it may be further facilitated to find the possible cause of the trouble in the transceiver 10.

The first memory 26 is a type of non-volatile memory. Therefore, even the power supply of the transceiver 10 is cut off due to a trouble, the maximum and minimum values of the monitored parameters and the accumulative time at the rewriting of the values are left in the memory, which may also enhance the investigation of the trouble.

The transceiver 10 according to the present embodiment may communicate with the host system via the interface 22. The host system communicating with the present transceiver 10 may watch the error flag in the second memory 28 and generates an alarm when the error flag is set. For example, when the error flag for the power supply voltage, the inner temperature of the transceiver or the optical input level is set, the host system, deciding that the operating condition is inadequate, may generates an alarm to correct the operating condition. When the error flag is set for the bias current or the optical output level, deciding that the optical transceiver 10 becomes in out of order, the host system may output an alarm to exchange the transceiver 10.

Furthermore, using the maximum or minimum value of the monitored parameter for the operating condition of the transceiver 10, it becomes possible to check whether the transceiver 10 suffers damage necessary to exchange. Accordingly, the host system may access the first memory 26 to read the maximum or minimum values stored therein when the error flag is set for the monitored parameters of the operating conditions, and may generate an alarm, instead of requesting the correction of the operating condition, to request the exchange of the transceiver 10 when the read maximum value is excessively greater, for example, exceeds the absolute maximum rating, or when the read minimum value is excessively smaller.

The transceiver 10, instead of the host system, may watch the error flag and may generate an alarm according to the procedure mentioned above.

The first memory 26 is a type of non-volatile memory, which has a restriction in the number of the rewriting. Therefore, it is preferable to set the width of the memory space such that the number of the rewriting for the maximum or minimum values does not exceed this restriction for the non-volatile memory 26.

At least the least significant bit (LSB) of the target address in the memory is carried at the rewriting because the rewriting of the maximum value occurs when the monitored parameter exceeds the stored maximum value. Similarly, for the rewriting of the minimum value, at least the LSB of the target address in the memory is borrowed because the rewriting of the minimum value occurs when the monitored parameter is less than the stored minimum value. Therefore, the number of the rewriting of the maximum or minimum value becomes equal to a number expressible by the bit width of the memory. For example, when the bit width is 16 bit, the number expressible by this bit width is 2¹⁶=65526, while, when the bit width is 15 bit, the maximum expressible number becomes 2¹⁵=32766. Moreover, the bit width assigned for storing the maximum or minimum value, namely, the bit width of the first memory, is necessary to be greater than the bit width of the A/D-C 32.

Therefore, it is necessary for the bit width of the first memory assigned for storing the maximum or minimum value of the monitored parameter to be larger than the bit width of the monitored parameter itself, and it is preferable that the number expressible by the bit width of the first memory is smaller than a number able to rewrite the non-volatile memory. For example, when the bit width of the A/D-C 32 is set 12 bits, the bit width of the first memory requires greater than 12 bits, and the non-volatile memory is necessary to have the number of the rewriting greater than 2¹²=4096.

The present invention is thus described as referring to embodiments thereof. However, the present invention is not restricted to those embodiments described in the specification. Various modifications without departing from the sprit thereof may be considered.

What is claimed is:

1. An optical transceiver, comprising:
a monitoring unit configured to monitor a parameter corresponding to an operating or ambient condition of the optical transceiver;
a first memory configured to store at least one of maximum and minimum values of the parameter; and
a comparator unit configured to compare the monitoring parameter and at least one of the maximum and minimum values, to rewrite the maximum value in the first memory when the monitored parameter is over the maximum value, and to rewrite the minimum value in the first memory when the monitored parameter is below the minimum value.

2. The optical transceiver according to claim 1,
further comprising: a second memory for storing a threshold and an error flag,
wherein the comparator unit is configured to compare the monitored parameter with the threshold and to set the error flag in the second memory when the monitored parameter is out of the threshold.

3. The optical transceiver according to claim 2,
wherein the comparator unit rewrites the maximum value when the monitored parameter is over the maximum value stored in the first memory and, at the same time, when the monitored parameter is out of the threshold, and the comparator unit rewrites the minimum value when the monitored parameter is below the minimum value stored in the first memory and, at the same time, when the monitored parameter is out of the threshold.

4. The optical transceiver according to claim 2,
further comprising: an interface connected to the first and the second memories,
wherein a host system provided outside of the optical transceiver accesses the first and second memories through the interface to read the error flag in the second memory, to read the maximum and minimum values in the first memory, and to write the threshold in the second memory.

5. The optical transceiver according to claim 1,
further comprising: a timer configured to count an operating time of the transceiver and to store an accumulated time.

6. The optical transceiver according to claim 5,
wherein the first memory stores the accumulated time in connection with the rewritten of the maximum or minimum value in the first memory by the comparator unit.

7. The optical transceiver according to claim 1,
wherein the first memory is a nonvolatile memory with a bit width greater than a bit width of the monitored parameter and smaller than a bit width corresponding to a rewritable number of the nonvolatile memory.

8. The optical transceiver according to claim 1,
wherein the optical transceiver includes a transmitting optical subassembly that installs a laser diode for emitting an optical output by supplying a bias current and a photodiode for monitoring the optical output, a receiving optical subassembly for receiving an optical input, a temperature sensor for sensing an inside temperature of the optical transceiver, and a Vcc sensor for monitoring a power supply voltage supplied to the optical transceiver, and
wherein the operating or ambient condition monitored by the monitoring unit includes at least one of the power supply voltage, the bias current, the optical output level, the optical input level, and the inside temperature.
